(19) United States
(12) Patent Application Publication
(10) Pub. No.: US 2015/0065413 A1
(43) Pub. Date: Mar. 5, 2015

(54) LAUNDRY DETERGENT PARTICLES

(71) Applicant: Conopco, Inc., d/b/a UNILEVER, Englewood Cliffs, NJ (US)

(72) Inventors: Stephen Norman Batchelor, Chester (GB); Andrew Paul Chapple, Gwynfryn (GB); Stephen Thomas Keningley, Bromborough (GB)

(73) Assignee: CONOPCO, INC., D/B/A UNILEVER, Englewood Cliffs, NJ (US)

(21) Appl. No.: 14/386,941

(22) PCT Filed: Feb. 15, 2013
(86) PCT No.: PCT/EP2013/053126

§ 371 Date: Sep. 22, 2014

(30) Foreign Application Priority Data
Apr. 3, 2012 (EP) 12163027

(51) Int. Cl. C11D 3/42; C11D 3/04; C11D 1/83; C11D 17/00

(52) U.S. Cl. CPC C11D 3/42; C11D 17/0039; C11D 3/046; C11D 1/83
USPC 510/394

(57) ABSTRACT

The present invention provides lenticular or disc detergent particles comprising (i) surfactat, (ii) inorganic salts, and (iii) dye, wherein the inorganic salts are present on the detergent particle as a coating and the surfactant and the dye are present as a core. The particles show reduced staining.

### FIELD OF INVENTION

The present invention relates to large laundry detergent particles.

### BACKGROUND OF INVENTION

WO9932599 describes a method of manufacturing laundry detergent particles, being an extrusion method in which a builder and surfactant, the latter comprising as a major component a sulphated or sulphonated anionic surfactant, are fed into an extruder, mechanically worked at a temperature of at least 40° C., preferably at least 60° C., and extruded through an extrusion head having a multiplicity of extrusion apertures. In most examples, the surfactant is fed to the extruder along with builder in a weight ratio of more than 1 part builder to 2 parts surfactant. The extrudate apparently required further drying. In Example 6, PAS paste was dried and extruded. Such PAS noodles are well known in the prior art. The noodles are typically cylindrical in shape and their length exceeds their diameter, as described in example 2.

U.S. Pat. No. 7,022,660 discloses a process for the preparation of a detergent particle having a coating.

WO 2010/122051 discloses coated detergent particles and a dye.

EP 2166 077 discloses particles comprising a core and a dye.

### SUMMARY OF THE INVENTION

We have found that it is possible to have a dye containing coating that give reduced staining. The invention may also increase the photostability of the dye in the product on storage.

In one aspect the present invention provides a coated detergent particle having perpendicular dimensions x, y and z, wherein x is from 0.5 to 2 mm, y is from 2 to 8 mm, and z is from 2 to 8 mm, wherein the particle comprises:

(i) from 20 to 39 wt % of a surfactant selected from: anionic and non-ionic surfactants;
(ii) from 10 to 40 wt % of inorganic salts selected from: sodium carbonate and/or sodium sulphate of which at least 5 wt % of the inorganic salt is sodium carbonate; and,
(iii) from 0.0001 to 0.1 wt % dye, wherein the dye is selected from: cationic dyes; anionic dyes; and, non-ionic dyes,
wherein the inorganic salts are present on the detergent particle as a coating and the surfactant and the dye are present as a core.

The coated detergent particle preferably comprises from 15 to 40 wt %, preferably 20 to 35 wt %, more preferably 25 to 30 wt %, of an active selected from: citric acid and sodium salts thereof and from 2 to 8 wt %, preferably 3 to 6 wt %, of a phosphonate sequestrant.

Unless otherwise stated all wt % refer to the total percentage in the particle as dry weights.

### DETAILED DESCRIPTION OF THE INVENTION

### Shape

Preferably the coated laundry detergent particle is curved.

The coated laundry detergent particle may be lenticular (shaped like a whole dried lentil), an oblate ellipsoid, where z and y are the equatorial diameters and x is the polar diameter; preferably y=z.

The coated laundry detergent particle may be shaped as a disc.

Preferably the coated laundry detergent particle does not have hole; that is to say, the coated laundry detergent particle does not have a conduit passing there though that passes through the core, i.e., the coated detergent particle has a topologic genus of zero.

### Core

### Surfactant

In general, the nonionic and anionic surfactants of the surfactant system may be chosen from the surfactants described “Surface Active Agents” Vol. 1, by Schwartz & Perry, lnterscience 1949, Vol. 2 by Schwartz, Perry & Berch, lnterscience 1958, in the current edition of “McCutcheon's Emulsifiers and Detergents” published by Manufacturing Confectioners Company or in “Tenside-Taschenbuch”, H. Stache, 2nd Edn., Carl Hauser Verlag, 1981. Preferably the surfactants used are saturated.

### Anionic Surfactants

Suitable anionic detergent compounds which may be used are usually water-soluble alkali metal salts of organic sulphates and sulphonates having alkyl radicals containing from about 8 to about 22 carbon atoms, the term alkyl being used to include the alkyl portion of higher acyl radicals. Examples of suitable synthetic anionic detergent compounds are sodium and potassium alkyl sulphates, especially those obtained by sulphating higher C₈ to C₁₈ alcohols, produced for example from tallow or coconut oil, sodium and potassium alkyl C₉ to C₂₀ benzene sulphonates, particularly sodium linear secondary alkyl C₁₀ to C₁₅ benzene sulphonates; and sodium alkyl glyceryl ether sulphates, especially those ethers of the higher alcohols derived from tallow or coconut oil and synthetic alcohols derived from petroleum. Most preferred anionic surfactants are sodium lauryl ether sulfate (SLES), particularly preferred with 1 to 3 ethoxy groups, sodium C₁₀ to C₁₅ alkyl benzene sulphonates and sodium C₁₂ to C₁₈ alkyl sulphates. Also applicable are surfactants such as those described in EP-A-328 177 (Unilever), which show resistance to salting-out, the alkyl polyglycoside surfactants described in EP-A-070 074, and alkyl monoglycosides. The chains of the surfactants may be branched or linear.

Soaps may also be present. The fatty acid soap used preferably contains from about 16 to about 22 carbon atoms, preferably in a straight chain configuration. The anionic contribution from soap is preferably from 0 to 30 wt % of the total anionic.

Preferably, at least 50 wt % of the anionic surfactant is selected from: sodium C₁₁ to C₁₅ alkyl benzene sulphonates; and, sodium C₁₂ to C₁₈ alkyl sulphates. Even more preferably, the anionic surfactant is sodium C₁₁ to C₁₅ alkyl benzene sulphonates.

### Nonionic Surfactants

Suitable nonionic detergent compounds which may be used include, in particular, the reaction products of compounds having a hydrophobic group and a reactive hydrogen atom, for example, aliphatic alcohols, acids, amides or alkyl phenols with alkylene oxides, especially ethylene oxide either alone or with propylene oxide. Preferred nonionic detergent compounds are C₆ to C₂₂ alkyl phenol-ethylene oxide condensates, generally 5 to 25 EO, i.e. 5 to 25 units of ethylene oxide per molecule, and the condensation products of aliphatic C₈ to C₁₈ primary or secondary linear or branched alcohols with ethylene oxide, generally 5 to 50 EO. Preferably, the non-ionic is 10 to 50 EO, more preferably 20 to 35 EO. Alkyl ethoxylates are particularly preferred.

Preferably all the surfactants are mixed together before being dried. Conventional mixing equipment may be used. The surfactant core of the laundry detergent particle may be formed by extrusion or roller compaction and subsequently coated with an inorganic salt.

### Calcium Tolerant Surfactant System

In another aspect the surfactant system used is calcium tolerant and this is a preferred aspect because this reduces the need for builder.

Surfactant blends that do not require builders to be present for effective detergency in hard water are preferred. Such blends are called calcium tolerant surfactant blends if they pass the test set out hereinafter. However, the invention may also be of use for washing with soft water, either naturally occurring or made using a water softener. In this case, calcium tolerance is no longer important and blends other than calcium tolerant ones may be used.

Calcium-tolerance of the surfactant blend is tested as follows:

The surfactant blend in question is prepared at a concentration of 0.7 g surfactant solids per litre of water containing sufficient calcium ions to give a French hardness of 40 (4×10⁻³ Molar Ca²⁺). Other hardness ion free electrolytes such as sodium chloride, sodium sulphate, and sodium hydroxide are added to the solution to adjust the ionic strength to 0.05M and the pH to 10. The adsorption of light of wavelength 540 nm through 4 mm of sample is measured 15 minutes after sample preparation. Ten measurements are made and an average value is calculated. Samples that give an absorption value of less than 0.08 are deemed to be calcium tolerant.

Examples of surfactant blends that satisfy the above test for calcium tolerance include those having a major part of LAS surfactant (which is not of itself calcium tolerant) blended with one or more other surfactants (co-surfactants) that are calcium tolerant to give a blend that is sufficiently calcium tolerant to be usable with little or no builder and to pass the given test. Suitable calcium tolerant co-surfactants include SLES 1-7EO, and alkyl-ethoxylate nonionic surfactants, particularly those with melting points less than 40° C.

### Inorganic Salts

The inorganic salt(s) is/are present as a coating on the particle. The inorganic salt(s) is/are preferably present at a level that reduces the stickiness of the laundry detergent particle to a point where the particles are free flowing.

It will be appreciated by those skilled in the art that while multiple layered coatings, of the same or different coating materials, could be applied, a single coating layer is preferred, for simplicity of operation, and to maximise the thickness of the coating.

The coating is preferably applied to the surface of the surfactant core, by deposition from an aqueous solution of the water soluble inorganic salt. In the alternative coating can be performed using a slurry. The aqueous solution preferably contains greater than 50 g/L, more preferably 200 g/L of the salt. An aqueous spray-on of the coating solution in a fluidised bed has been found to give good results and may also generate a slight rounding of the detergent particles during the fluidization process. Drying and/or cooling may be needed to finish the process.

### Dye

Dyes are described in Industrial Dyes edited by K. Hunger 2003 Wiley-VCH ISBN 3-527-30426-6.

Dyes for use in the current invention are selected from cationic, anionic and non-ionic dyes. Anionic dyes are negatively charged in an aqueous medium at pH 7. Examples of anionic dyes are found in the classes of acid and direct dyes in the Color Index (Society of Dyers and Colourists and American Association of Textile Chemists and Colorists). Anionic dyes preferably contain at least one sulphonate or carboxylate groups. Non-ionic dyes are uncharged in an aqueous medium at pH 7, examples are found in the class of disperse dyes in the Color Index. Cationic dyes are positively charged in an aqueous medium at pH 7, preferably the cationic charge is on a pendant quaternary amine.

The dyes may be alkoxylated. Alkoxylated dyes are preferably of the following generic form: Dye-NR₁R₂. The NR₁R₂ group is attached to an aromatic ring of the dye. R₁ and R₂ are independently selected from polyoxyalkylene chains having 2 or more repeating units and preferably having 2 to 20 repeating units. Examples of polyoxyalkylene chains include ethylene oxide, propylene oxide, glycidol oxide, butylene oxide and mixtures thereof.

A preferred polyoxyalkylene chain is [(CH₂CR₃HO)ₓ(CH₂CR₄HO)_{y}R₅) in which x+y·5 wherein y·1 and z=0 to 5, R₃ is selected from: H; CH₃; CH₂O(CH₂CH₂O)_{z}H and mixtures thereof; R₄ is selected from: H; CH₂O(CH₂CH₂O)_{z}H and mixtures thereof; and, R₅ is selected from: H; and, CH₃.

A preferred alkoxylated dye for use in the invention is:

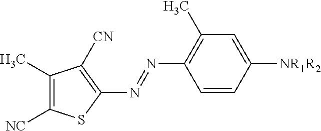

Preferably the dye is selected from acid dyes; disperse dyes and alkoxylated dyes.

Most preferably the dye is an anionic or non-ionic dye. It is even more preferred that the dye is a non-ionic dye.

Preferably the dye is selected from those having: anthraquinone; mono-azo; bis-azo; xanthene; phthalocyanine; and, phenazine chromophores. More Preferably the dye is selected from those having: anthraquinone and, mono-azo chromophores.

The dye is added to the coating slurry and agitated before applying to the core of the particle. Application may be by any suitable method, preferably spraying on to the core particle as detailed above.

The dye may be any colour, preferable the dye is blue, violet, green or red. Most preferably the dye is blue or violet.

Preferably the dye is selected from: acid blue 80, acid blue 62, acid violet 43, acid green 25, direct blue 86, acid blue 59, acid blue 98, direct violet 9, direct violet 99, direct violet 35, direct violet 51, acid violet 50, acid yellow 3, acid red 94, acid red 51, acid red 95, acid red 92, acid red 98, acid red 87, acid yellow 73, acid red 50, acid violet 9, acid red 52, food black 1, food black 2, acid red 163, acid black 1, acid orange 24, acid yellow 23, acid yellow 40, acid yellow 11, acid red 180, acid red 155, acid red 1, acid red 33, acid red 41, acid red 19, acid orange 10, acid red 27, acid red 26, acid orange 20, acid orange 6, sulphonated Al and Zn phthalocyanines, solvent violet 13, disperse violet 26, disperse violet 28, solvent green 3, solvent blue 63, disperse blue 56, disperse violet 27, solvent yellow 33, disperse blue 79:1.

The dye is preferably a shading dye for imparting a perception of whiteness to a laundry textile, preferably acid violet 50, solvent violet 13, disperse violet 27, disperse violet 28, an alkoxylated thiophene, or a cationic phenazine as described in WO 2009/141172 and WO 2009/141173. When a shading dye is present, preferably a further green dye is present to shift the colour of the particle from violet to blue-green.

The dye may be covalently bound to polymeric species.

A combination of dyes may be used.

### The Coated Laundry Detergent Particle

Preferably, the coated laundry detergent particle comprises from 10 to 100 wt %, more preferably 50 to 100 wt %, of a laundry detergent formulation in a package.

The package is that of a commercial formulation for sale to the general public and is preferably in the range of 0.01 kg to 5 kg, preferably 0.02 kg to 2 kg, most preferably 0.5 kg to 2 kg.

Preferably, the coated laundry detergent particle is such that at least 90 to 100% of the coated laundry detergent particles in the in the x, y and z dimensions are within a 20%, preferably 10%, variable from the largest to the smallest coated laundry detergent particle.

### Water Content

The particle preferably comprises from 0 to 15 wt % water, more preferably 0 to 10 wt %, most preferably from 1 to 5 wt % water, at 293K and 50% relative humidity. This facilitates the storage stability of the particle and its mechanical properties.

### Other Adjuncts

The adjuncts as described below may be present in the coating or the core. These may be in the core or the coating.

### Fluorescent Agent

The coated laundry detergent particle preferably comprises a fluorescent agent (optical brightener). Fluorescent agents are well known and many such fluorescent agents are available commercially. Usually, these fluorescent agents are supplied and used in the form of their alkali metal salts, for example, the sodium salts. The total amount of the fluorescent agent or agents used in the composition is generally from 0.005 to 2 wt %, more preferably 0.01 to 0.1 wt %. Suitable Fluorescer for use in the invention are described in chapter 7 of Industrial Dyes edited by K. Hunger 2003 Wiley-VCH ISBN 3-527-30426-6.

Preferred fluorescers are selected from the classes distyrylbiphenyls, triazinylaminostilbenes, bis(1,2,3-triazol-2-yl)stilbenes, bis(benzo[b]furan-2-yl)biphenyls, 1,3-diphenyl-2-pyrazolines and courmarins. The fluorescer is preferably sulfonated.

Preferred classes of fluorescer are: Di-styryl biphenyl compounds, e.g. Tinopal (Trade Mark) CBS-X, Di-amine stilbene di-sulphonic acid compounds, e.g. Tinopal DMS pure Xtra and Blankophor (Trade Mark) HRH, and Pyrazoline compounds, e.g. Blankophor SN. Preferred fluorescers are: sodium 2 (4-styryl-3-sulfophenyl)-2H-napthol[1,2-d]triazole, disodium 4,4′-bis{[(4-anilino-6-(N methyl-N-2 hydroxyethyl) amino 1,3,5-triazin-2-yl)]amino}stilbene-2-2′disulfonate, disodium 4,4′-bis{[(4-anilino-6-morpholino-1,3,5-triazin-2-yl)]amino}stilbene-2-2′disulfonate, and disodium 4,4′-bis(2-sulfostyryl)biphenyl.

Tinopal® DMS is the disodium salt of disodium 4,4′-bis{[(4-anilino-6-morpholino-1,3,5-triazin-2-yl)]amino}stilbene-2-2′disulfonate. Tinopal® CBS is the disodium salt of disodium 4,4′-bis(2-sulfostyryl)biphenyl.

### Perfume

Preferably the composition comprises a perfume. The perfume is preferably in the range from 0.001 to 3 wt %, most preferably 0.1 to 2 wt %. Many suitable examples of perfumes are provided in the CTFA (Cosmetic, Toiletry and Fragrance Association) 1992 International Buyers Guide, published by CFTA Publications and OPD 1993 Chemicals Buyers Directory 80th Annual Edition, published by Schnell Publishing Co.

It is commonplace for a plurality of perfume components to be present in a formulation. In the compositions of the present invention it is envisaged that there will be four or more, preferably five or more, more preferably six or more or even seven or more different perfume components.

In perfume mixtures preferably 15 to 25 wt % are top notes. Top notes are defined by Poucher (Journal of the Society of Cosmetic Chemists 6(2):80 [1955]). Preferred top-notes are selected from citrus oils, linalool, linalyl acetate, lavender, dihydromyrcenol, rose oxide and cis-3-hexanol.

The perfume serves to disaggregate the dye to make the dye more visible.

It is preferred that the coated laundry detergent particle does not contain a peroxygen bleach, e.g., sodium percarbonate, sodium perborate, and peracid.

### Polymers

The composition may comprise one or more further polymers. Examples are carboxymethylcellulose, poly(ethylene glycol), poly(vinyl alcohol), polyethylene imines, ethoxylated polyethylene imines, water soluble polyester polymers polycarboxylates such as polyacrylates, maleic/acrylic acid copolymers and lauryl methacrylate/acrylic acid copolymers.

### Enzymes

One or more enzymes are preferred present in a composition of the invention.

Preferably the level of each enzyme is from 0.0001 wt % to 0.5 wt % protein on product.

Especially contemplated enzymes include proteases, alpha-amylases, cellulases, lipases, peroxidases/oxidases, pectate lyases, and mannanases, or mixtures thereof.

Suitable lipases include those of bacterial or fungal origin. Chemically modified or protein engineered mutants are included. Examples of useful lipases include lipases from Humicola (synonym Thermomyces), e.g. from H. lanuginosa (T. lanuginosus) as described in EP 258 068 and EP 305 216 or from H. insolens as described in WO 96/13580, a Pseudomonas lipase, e.g. from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and WO 96/27002), P. wisconsinensis (WO 96/12012), a Bacillus lipase, e.g. from B. subtilis (Dartois et al. (1993), Biochemica et Biophysica Acta, 1131, 253-360), B. stearothermophilus (JP 64/744992) or B. pumilus (WO 91/16422).

Other examples are lipase variants such as those described in WO 92/05249, WO 94/01541, EP 407 225, EP 260 105, WO 95/35381, WO 96/00292, WO 95/30744, WO 94/25578, WO 95/14783, WO 95/22615, WO 97/04079 and WO 97/07202, WO 00/60063, WO 09/107091 and WO09/111258.

Preferred commercially available lipase enzymes include Lipolase™ and Lipolase Ultra™, Lipex™ (Novozymes A/S) and Lipoclean™.

The method of the invention may be carried out in the presence of phospholipase classified as EC 3.1.1.4 and/or EC 3.1.1.32. As used herein, the term phospholipase is an enzyme which has activity towards phospholipids.

Phospholipids, such as lecithin or phosphatidylcholine, consist of glycerol esterified with two fatty acids in an outer (sn-1) and the middle (sn-2) positions and esterified with phosphoric acid in the third position; the phosphoric acid, in turn, may be esterified to an amino-alcohol. Phospholipases are enzymes which participate in the hydrolysis of phospholipids. Several types of phospholipase activity can be distinguished, including phospholipases A₁ and A₂ which hydrolyze one fatty acyl group (in the sn-1 and sn-2 position, respectively) to form lysophospholipid; and lysophospholipase (or phospholipase B) which can hydrolyze the remaining fatty acyl group in lysophospholipid. Phospholipase C and phospholipase D (phosphodiesterases) release diacyl glycerol or phosphatidic acid respectively.

Suitable proteases include those of animal, vegetable or microbial origin. Microbial origin is preferred. Chemically modified or protein engineered mutants are included. The protease may be a serine protease or a metallo protease, preferably an alkaline microbial protease or a trypsin-like protease. Preferred commercially available protease enzymes include Alcalase™, Savinase™, Primase™ Duralase™, Dyrazym™, Esperase™, Everlase™, Polarzyme™, and Kannase™ (Novozymes A/S), Maxatase™, Maxacal™, Maxapem™, Properase™ Purafect™, Purafect OxP™, FN2™, and FN3™ (Genencor International Inc.). The method of the invention may be carried out in the presence of cutinase. classified in EC 3.1.1.74. The cutinase used according to the invention may be of any origin. Preferably cutinases are of microbial origin, in particular of bacterial, of fungal or of yeast origin.

Suitable amylases (alpha and/or beta) include those of bacterial or fungal origin. Chemically modified or protein engineered mutants are included. Amylases include, for example, alpha-amylases obtained from Bacillus, e.g. a special strain of B. licheniformis, described in more detail in GB 1,296,839, or the Bacillus sp. strains disclosed in WO 95/026397 or WO 00/060060. Commercially available amylases are Duramyl™, Termamyl™, Termamyl Ultra™, Natalase™ Stainzyme™, Fungamyl™ and BAN™ (Novozymes A/S), Rapidase™ and Purastar™ (from Genencor International Inc.).

Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g. the fungal cellulases produced from Humicola insolens, Thielavia terrestris, Myceliophthora thermophila, and Fusarium oxysporum disclosed in U.S. Pat. No. 4,435,307, U.S. Pat. No. 5,648,263, U.S. Pat. No. 5,691,178, U.S. Pat. No. 5,776,757, WO 89/09259, WO 96/029397, and WO 98/012307. Commercially available cellulases include Celluzyme™, Carezyme™, Endolase™, Renozyme™ (Novozymes A/S), Clazinase™ and Puradax HA™ (Genencor International Inc.), and KAC-500(B)™ (Kao Corporation).

Suitable peroxidases/oxidases include those of plant, bacterial or fungal origin. Chemically modified or protein engineered mutants are included. Examples of useful peroxidases include peroxidases from Coprinus, e.g. from C. cinereus, and variants thereof as those described in WO 93/24618, WO 95/10602, and WO 98/15257. Commercially available peroxidases include Guardzyme™ and Novozym™ 51004 (Novozymes A/S).

Further enzymes suitable for use are disclosed in WO2009/087524, WO2009/090576, WO2009/148983 and WO2008/007318.

### Enzyme Stabilizers

Any enzyme present in the composition may be stabilized using conventional stabilizing agents, e.g., a polyol such as propylene glycol or glycerol, a sugar or sugar alcohol, lactic acid, boric acid, or a boric acid derivative, e.g., an aromatic borate ester, or a phenyl boronic acid derivative such as 4-formylphenyl boronic acid, and the composition may be formulated as described in e.g. WO 92/19709 and WO 92/19708.

Where alkyl groups are sufficiently long to form branched or cyclic chains, the alkyl groups encompass branched, cyclic and linear alkyl chains. The alkyl groups are preferably linear or branched, most preferably linear.

The indefinite article “a” or “an” and its corresponding definite article “the” as used herein means at least one, or one or more, unless specified otherwise. The singular encompasses the plural unless otherwise specified.

Sequesterants may be present in the coated laundry detergent particles.

It is preferred that the coated detergent particle has a core to shell ratio of from 3 to 1:1, most preferably 2.5 to 1.5:1; the optimal ratio of core to shell is 2:1.

### EXPERIMENTAL

### Example 1

### Particle Manufacture

Laundry detergent particles containing Acid Violet 50 were manufactured as follows. Particle 1 and Particle 3 had the dye in the core and Particle 2 was a reference particle with the dye in a coating with SOKOLAN CP5 (a copolymer of about equal moles of methacrylic acid and maleic anhydride, completely neutralized to form the sodium salt). The particles were oblate ellipsoids which had the following approximate dimensions x=1.0 mm y=4.0 mm z=5.0 mm.

### Core Manufacture

Surfactant raw materials were mixed together to give a 69 wt % active paste comprising 85 parts of anionic surfactant linear alkyl benzene sulphonate (Ufasan 65 ex Unger) LAS, and 15 parts Nonionic Surfactant (Slovasol 2430 ex Sasol). The paste was pre-heated to the feed temperature and fed to the top of a wiped film evaporator to reduce the moisture content and produce a solid intimate surfactant blend, which passed the calcium tolerance test.

After leaving the chill roll, the cooled dried surfactant blend particles were milled. The resulting milled material is hygroscopic and so it was stored in sealed containers. The cooled dried milled composition was fed to a twin-screw co-rotating extruder fitted with a shaped orifice plate and cutter blade. A number of other components were also dosed into the extruder as shown in the table below:

| | Particle | Particle |
|---|---|---|
| | 1 & 3 | 2 |
| LAS/30 EO Base | 40.3% | 40.3% |
| Dequest 2016 | 7.7% | 7.7% |
| Citric acid | 10.6% | 10.6% |
| Na Citrate | 32.3% | 32.3% |
| enzyme | 3.5% | 3.5% |
| Soil Release Polymer | 2.8% | 2.8% |
| Perfume | 1.4% | 1.4% |
| Moisture | 1.4% | 1.4% |
| AV50 | 0.007% | |
| TOTAL | 100.0% | 100.0% |

The resultant core particles were then coated as outlined below:

### Coating

The core particles were coated with Sodium carbonate (particle 1) or CP5 (particle 2 reference) by spray. The extrudates above were charged to the fluidizing chamber of a Strea 1 laboratory fluid bed drier (Aeromatic-Fielder AG) and spray coated using the coating solution using a top-spray configuration. The coating solution was fed to the spray nozzle of the Strea 1 via a peristaltic pump (Watson-Marlow model 101 U/R). The composition of the coatings are given in the table below:

| | Particle 1 | Particle 2 (reference) | Particle 3 |
|---|---|---|---|
| | Dye in core | Dye in coating | Dye in Core |
| Mass extrudate [g] | 800 | 800 | 800 |
| Coating Solution [g] | 225 Na₂CO₃ | 56.3 CP5 | 56.3 Na₂CO₃ |
| | 525 H₂O | 225 H₂O | 225 H₂O |
| | 2.9 Fluorescer | 2.9 Fluorescer | 2.9 Fluorescer |
| | | 0.056 AV50 | |

For particle 1, particle 2 (reference) and particle 3, an identical level of dye (0.056 g of Acid violet 50 (AV50)) was used to produce the granules. In particle 1 and particle 3 the AV50 (phenazine chromophore) was in the core of the particle. For particle 2 (reference) AV50 was in the coating. The concentration of Acid Violet 50 in the granules is 0.065 g Acid Violet 50 per 1000 g of granules for particle 2 (reference) and particle 3.

### Example 2

### Spotting Properties

25 of each particle were scattered on to a 20 by 20 cm piece of wet white woven cotton laid flat on a table. The wet white woven cotton had been submerged in 500 ml of demineralised water for 2 minutes, removed wrung and used for the experiment. The particles were left for 40 minutes at room temperature then the cloth rinsed and dried. Clearly visible blue stains were given a score of 3. Faint stains were given a score of 1. The total stain score was then calculated as

Total Stain Score=·(score)

| | Particle 1 | Particle 2 (reference) | Particle 3 |
|---|---|---|---|
| | Dye in core | Dye in coating | Dye in core |
| Total Stain Score | 7 | 48 | 0 |

1. A coated detergent particle having perpendicular dimensions x, y and z, wherein x is from 0.5 to 2 mm, y is from 2 to 8 mm, and z is from 2 to 8 mm, wherein the particle comprises:
(i) from 20 to 39 wt % of a surfactant selected from: anionic and non-ionic surfactants;
(ii) from 10 to 40 wt % of inorganic salts selected from: sodium carbonate and/or sodium sulphate of which at least 5 wt % of the inorganic salt is sodium carbonate; and,
(iii) from 0.0001 to 0.1 wt % dye, wherein the dye is selected from: cationic dyes: anionic dyes; and, non-ionic dyes,
wherein the inorganic salts are present on the detergent particle as a coating and the surfactant and the dye are present as a core, wherein the dye is selected from those having: anthraquinone; mono-azo; bis-azo; xanthene; phthalocyanine; and, phenazine chromophores.

2. A coated detergent particle according to claim 1, wherein the dye is selected from acid dyes; disperse dyes and alkoxylated dyes.

3. A coated detergent particle according to claim 1, wherein the dye has a phenazine chromophore.

4. A coated detergent particle according to claim 1, wherein the dye is selected from those having: anthraquinone and mono-azo; chromophores.

5. A coated detergent particle according to claim 1, wherein the dye is selected from non-ionic dyes.

6. A coated detergent particle according to claim 1, wherein the total surfactant of the coated detergent particle comprises from 15 to 85 wt % anionic and from 5 to 75 wt % non-ionic surfactant.

7. A coated detergent particle according to claim 1, wherein the particle comprises from 0 to 15 wt % water.

8. A coated detergent particle according to claim 7, wherein the particle comprises from 1 to 5 wt % water.

9. A detergent formulation comprising coated detergent particles according to claim 8, wherein the coated detergent particle comprises from 50 to 100 wt % of the detergent formulation in a package.

10. A detergent formulation comprising coated detergent particles according to claim 9, wherein the coated detergent particle comprises from 80 to 100 wt % of the detergent formulation in a package.

11. A detergent formulation comprising coated detergent particles according to claim 9, wherein at least 90 to 100% of the coated detergent particles in the in the x, y and z dimensions are within a 20% variable from the largest to the smallest coated detergent particle.
